(19) United States
(12) Patent Application Publication
(10) Pub. No.: US 2021/0223873 A1
(43) Pub. Date: Jul. 22, 2021

(54) POINTING DEVICE

(71) Applicant: LG ELECTRONICS INC., Seoul (KR)

(72) Inventors: Jongpil KIM, Seoul (KR); Jinbum KIM, Seoul (KR); Joonwon BYUN, Seoul (KR); Jeongho WOO, Seoul (KR); Dongjin LEE, Seoul (KR); Sungbum JOO, Seoul (KR)

(73) Assignee: LG ELECTRONICS INC., Seoul (KR)

(21) Appl. No.: 17/056,680

(22) PCT Filed: Sep. 21, 2018
(86) PCT No.: PCT/KR2018/011218

§ 371 Date: Nov. 18, 2020

(30) Foreign Application Priority Data
Jun. 1, 2018 (KR) 10-2018-0063798

(51) Int. Cl. G06F 3/0354; G02B 7/02; G02B 5/18; G02B 3/04

(52) U.S. Cl. CPC G06F 3/03542; G02B 3/04; G02B 5/1876; G02B 7/02

(57) ABSTRACT

Provided is a pointing device having an optical module for coordinate tracking in order to solve the problem that a pointing device using the diffraction principle of light increases in size due to an optical module, wherein the optical module comprises: a light-emitting unit which irradiates light toward an outside surface; a lens unit provided between the light-emitting unit and the outside surface to refract and diffract the light; and a light receiving unit to which the light reflected from the outside surface through the lens unit reaches, wherein the light receiving unit comprises a detector which senses the reflected light, and a light receiving surface of the detector is inclined at a specific angle toward the optical axis of the light-emitting unit.

### TECHNICAL FIELD

The present disclosure relates to a pointing device having an optical module for tracking a coordinate that senses pointing and movement using diffraction of light.

### BACKGROUND ART

A conventional pen-shaped pointing device functions as a pointing device by being linked with another device in several forms.

As a representative form, there is a contact pen pointing device that is in a direct touch or in a proximity touch with an input target such as a touch screen of a terminal to induce a change in capacitance of the touch screen.

In principle, the contact pen pointing device does not require a separate battery, and has an advantage of being intuitive in that the contact pen pointing device physically contacts the touch screen to perform an input.

However, because the touch pen pointing device must directly be in contact with the touch screen, a writing region is limited. This means that it is difficult to adjust a ratio because a distance moved for writing and an input distance are in one-one correspondence with each other in principle. Furthermore, because there are restrictions on a material of the touch screen, various writing feelings are not able to be generated.

A non-contact pen pointing device compensates for such disadvantage. Because the non-contact pen pointing device performs the input by tracking a movement thereof, there is no limit to a target object in principle. Therefore, even when the writing is performed on the target object such as a notebook, a desk, or the like other than an electronic device, an intended handwriting input or the like may be performed.

Among operating principles of such a non-contact pen pointing device, there is a scheme using a principle of diffraction of light. However, when the principle of diffraction of the light is used, because a size of an optical module mounted on the pointing device to drive the pointing device is large, there is a limitation in miniaturizing the pointing device.

### DISCLOSURE

### Technical Purpose

The present disclosure aims to minimize a problem of increasing a volume of a pointing device resulted from an optical module, which is the aforementioned problem.

### Technical Solutions

According to one aspect of the present disclosure to achieve the above or other purposes, provided is a pointing device including an optical module for tracking a coordinate, wherein the optical module includes a light emitter for irradiating light towards an outside surface, a lens disposed between the light emitter and the outside surface to refract and diffract the light, and a light receiver, wherein the light passed through the lens and then reflected from the outside surface reaches the light receiver, wherein the light receiver includes a detector for sensing the reflected light, wherein a light receiving surface of the detector is inclined at a specific angle with respect to an optical axis of the light emitter.

Further, according to another aspect of the present disclosure, provided is the pointing device, wherein the optical module further includes a casing for mounting the light emitter, the lens, and the light receiver therein, wherein a width of the casing with respect to a first direction perpendicular to the optical axis of the light emitter corresponds to a width occupied by the light receiver with respect to the first direction.

Further, according to another aspect of the present disclosure, provided is the pointing device, wherein the lens includes a lens for performing the refraction of the light, and a grating element for performing the diffraction of the light.

Further, according to another aspect of the present disclosure, provided is the pointing device, wherein the lens includes a single lens for performing the refraction and the diffraction of the light.

Further, according to another aspect of the present disclosure, provided is the pointing device, wherein the lens performs linear type diffraction and includes an aspherical lens.

Further, according to another aspect of the present disclosure, provided is the pointing device, wherein the lens is a single grating element performing kinoform type diffraction.

Further, according to another aspect of the present disclosure, provided is a pointing device including an optical module for tracking a coordinate, wherein the optical module includes a light emitter for irradiating light towards an outside surface, a lens disposed between the light emitter and the outside surface to refract and diffract the light, and a light receiver, wherein the light passed through the lens and then reflected from the outside surface reaches the light receiver, wherein the light receiver has three detectors for sensing the light.

Further, according to another aspect of the present disclosure, provided is the pointing device, wherein the three detectors are arranged biased on one side with respect to a centerline passing through the light emitter.

Further, according to another aspect of the present disclosure, provided is the pointing device, wherein the three detectors are respectively disposed at three of four respective locations above, below, left and right to the light emitter.

Further, according to another aspect of the present disclosure, provided is a pointing device including an optical module for tracking a coordinate, wherein the optical module includes a light emitter for irradiating light toward an outside surface and forming an optical path, a lens disposed between the light emitter and the outside surface to refract and diffract the light, and a light receiver, wherein the light passed through the lens and then reflected from the outside surface reaches the light receiver, wherein the light receiver is located behind the light emitter in the optical path.

Further, according to another aspect of the present disclosure, provided is a pointing device including an optical module for tracking a coordinate, wherein the optical module includes a light emitter for irradiating light toward an outside surface and forming an optical path, a lens disposed between the light emitter and the outside surface to refract and diffract the light, and a light receiver, wherein the light passed through the lens and then reflected from the outside surface reaches the light receiver, wherein the light receiver is located in front of the light emitter in the optical path.

### Advantageous Effects

Effect of a mobile terminal according to the present disclosure will be described as follows.

According to at least one of the embodiments of the present disclosure, a size of the pointing device may be reduced.

Further, according to at least one of the embodiments of the present disclosure, there is an advantage in that a movement of the pointing device may be accurately recognized.

Further scope of the applicability of the present disclosure will become apparent from a detailed description below. However, various changes and modifications within the spirit and scope of the present disclosure may be clearly understood by those skilled in the corresponding technical field, so that it is to be understood that the detailed description and specific embodiments such as preferred embodiments of the present disclosure are given by way of example only.

### DESCRIPTION OF DRAWINGS

FIG. 1 shows a pointing device related to the present disclosure.

FIG. 2 shows a cross-section of an optical module related to an embodiment of the present disclosure.

FIG. 3 shows a cross-section of an optical module related to another embodiment of the present disclosure.

FIG. 4 shows a cross-section of an optical module related to another embodiment of the present disclosure.

FIG. 5 shows an embodiment of an optical module related to the present disclosure.

FIG. 6 shows another embodiment of an optical module related to the present disclosure.

FIG. 7 shows an embodiment of an optical module related to the present disclosure.

FIG. 8 shows another embodiment of an optical module related to the present disclosure.

FIGS. 9 to 11 show some examples of an optical module related to the present disclosure.

### BEST MODE

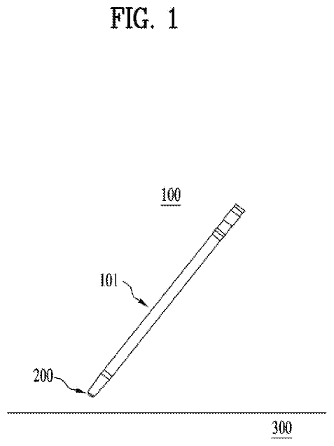

FIG. 1 shows a pointing device 100 related to the present disclosure.

The pointing device 100 of the present disclosure generates an input signal by writing on an arbitrary outside surface 301. Such input signal contains movement information on top, bottom, left, and right components on the outside surface 301 of the pointing device 100. The input signal may be implemented as writing information or information for performing a specific function for the corresponding pointing device 100 or an external device connected to the pointing device 100.

In that it is writing performed on the arbitrary outside surface 301, the pointing device 100 of the present disclosure has no particular restriction on a target object 300. Such feature is distinguished from a conventional pointing device that is able to write only on a touch screen.

To implement the pointing device 100 having the feature, the pointing device 100 includes an optical module 200 for emitting light and receiving the emitted light. Specifically, the optical module 200 tracks a coordinate in which the pointing device 100 moves by recognizing a movement and a moving direction of the pointing device 100 using principles of refraction and diffraction of the light.

The pointing device 100 includes a body 101 for being gripped by a user and the optical module 200 mounted on the body 101. When necessary, a component (e.g., a physical button) for generating the input signal by a method other than the writing may be additionally implemented.

The input signal generated through the optical module 200 or the like may be transmitted to an external device through a wireless communication device. For example, when the input signal generated from the pointing device 100 contains movement information of moving to the right with respect to the outside surface 301, that is, a writing surface, this may be transmitted to a mobile terminal and cause an effect of moving a pointer to the right.

In this connection, the optical module 200 needs to irradiate the light to the outside surface 301 and receive the light again, so that it is preferable that the optical module 200 is disposed at an end of the pointing device 100 facing the outside surface 301.

The pointing device 100 may also include a power supply for electrical operations of the components.

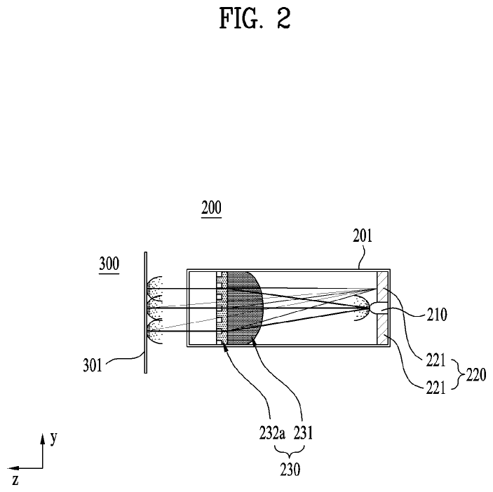

FIG. 2 shows a cross-section of the optical module 200 related to an embodiment of the present disclosure.

A light emitter 210 irradiates the light toward the outside surface 301. Because the light irradiated through the light emitter 210 has a spreading property, that is, a divergence property, it is efficient in terms of energy that the light emitter 210 is disposed at a center of a casing 201 of the optical module 200.

In particular, the light emitter 210 may be a vertical-cavity surface-emitting laser (hereinafter, a VCSEL).

A light receiver 220 receives the light irradiated through the light emitter 210 when the light is reflected back to the outside surface 301. The received light may be analyzed and converted into the movement information of the pointing device 100.

A lens 230 refracts and diffracts the emitted light to allow the light receiver 220 to receive the light with appropriate information.

The lens 230 refracts the light passing through the lens 230. The lens 230 allows the light emitted from the light emitter 210 and diverging to travel in parallel, and also refracts the light reflected from the outside surface 301 to reach the light receiver 220 again.

The lens 230 diffracts the light passing through lens 230. The lens 230 diffracts the light reflected from the outside surface 301 to reach the light receiver 220. The reflected light is diffracted, so that only the appropriate information may be collected. In particular, the light receiver 220 may analyze only light of a 1st order or −1st order of the diffracted light. This is because diffracted light of the 1st order or the −1st order has a relatively high efficiency.

The lens 230 may include a lens 231 in charge of the refraction and a grating element 232 in charge of the diffraction. The grating element 232 is disposed at an outer side of the lens 230 and the lens 231 is disposed at an inner side of the lens 230.

In summary, the light emitted from the light emitter 210 passes through the lens 231 and the grating element 232 in sequence, then, is reflected from the outside surface 301, then, passes through the grating element 232 and the lens 231 again in sequence, and then, reaches the light receiver 220. In this connection, the diffraction of the light occurs when the light is reflected from the outside surface 301 and enters the optical module 200. Thus, a patterned surface 2321 of the grating element 232 is configured to be directed outward to face the outside surface 301.

In particular, the embodiment in FIG. 2 shows the linear diffraction type optical module 200. In the linear diffraction type, a linear grating element 232a is used.

The linear grating element 232a is the grating element 232 in the same periodic scheme. Because there is no focus point, the lens 231 that performs focusing must be disposed.

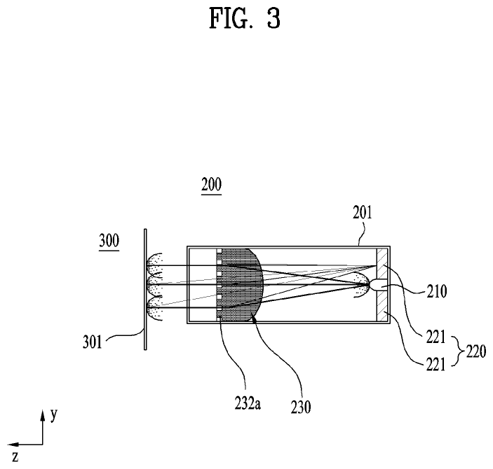

FIG. 3 shows a cross-section of the optical module 200 related to another embodiment of the present disclosure. Features that overlap with the embodiment in FIG. 2 will be omitted.

Unlike the embodiment in FIG. 2, the lens 230 of the linear diffraction type optical module 200 may be implemented in a form of a single lens. That is, the patterned surface 2321 that performs a function of the grating element 232 (see FIG. 2) may be disposed on an outside surface of the lens 231a that performs the refraction.

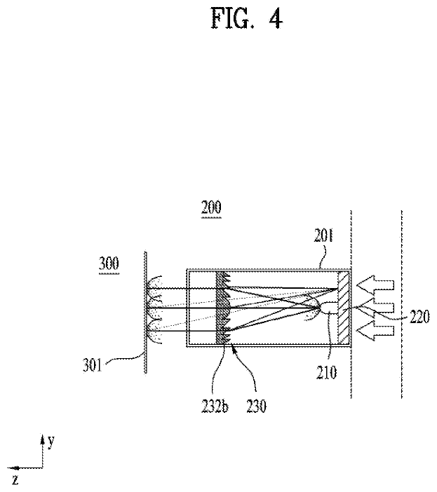

FIG. 4 shows a cross-section of the optical module 200 related to another embodiment of the present disclosure. Features that overlap with the embodiment in FIG. 2 will be omitted. Unlike the embodiment in FIG. 2 or FIG. 3, the pointing device may use the kinoform diffraction type optical module 200. In this case, the lens 230 may be composed of only a kinoform grating element 232b. Because the kinoform grating element 232b itself forms the focus point, the separate lens 231 (see FIG. 2) performing the refraction may be omitted.

Therefore, because the lens 231 is able to be omitted, the kinoform diffraction type optical module 200 may reduce a length of the optical module 200. This is distinguished from the case of the linear diffraction type optical module 200 in FIG. 2 or FIG. 3, which must have the lens 231 for the refraction.

Referring to FIGS. 2 to 4 together, the light receiver 220 receives light emitted from the light emitter 210 and then reflected inside the optical module 200 or reflected from the outside surface 301 outside the optical module 200. The light reflected inside the optical module 200 provides a reference value to be distinguished from the light reflected from the outside surface 301 outside the optical module 200.

The light receiver 220 tracks a movement of the pointing device 100 by sensing a shape or a change in the shape of the light arriving.

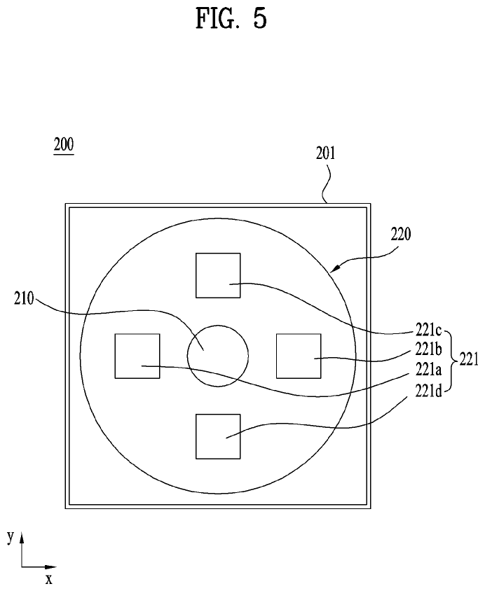

FIG. 5 shows an embodiment of the optical module 200 related to the present disclosure. The light receiver 220 may include a plurality of detectors 221. In principle, one detector 221 receives light reaching one point. Because the movement of the pointing device is not able to be recognized with a measurement value of the light for one point, because the plurality of detectors 221 should be implemented.

As an example, the light receiver may have four detectors 221. Assuming that a plane perpendicular to an optical axis of light emitter 210 is an x-y plane, two detectors 221a and 221b respectively located on left and right of the light emitter 210 may receive diffracted light of a 1st order and a −1st order of an x-axis, and two detectors 221c and 221d respectively located above and below the light emitter 210 may receive rotated light of a 1st order and a −1st order of an y-axis.

Locations of the four detectors 221a, 221b, 221c, and 221d may be changed as required.

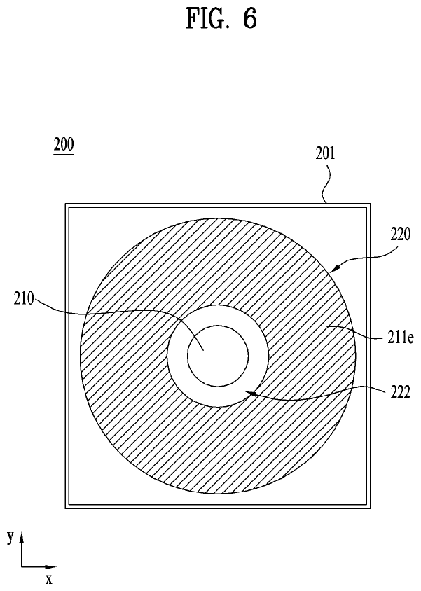

FIG. 6 shows another embodiment of the optical module 200 related to the present disclosure.

As another example, the light receiver 220 may include a detector 221e that is disposed over a certain area. The detector 221e disposed over the certain area may have a donut shape surrounding the light emitter 210 on the x-y plane. The detector 221e may be formed in a circular shape with a width in a left and right direction and a width in an up and down direction that are the same, but may be formed in an oval shape based on a need of a light receiving area or the like taking into account an overall shape of the pointing device 100 or a direction in which the pointing device 100 is mainly inclined.

In this case, the detector 221e may receive light for countless points, so that there is an advantage in that a necessary point from the received light information may be selectively analyzed, thereby improving accuracy.

In principle, it is preferable that the light receiver 220 be installed on the same line as the light emitter 210 with respect to a direction of the optical axis. This is because the optical axis is a common region where the light reflected inside without exiting the optical module 200 and the light reflected from the outside surface 301 outside the optical module 200 and then enters the optical module 200 again of the light emitted from the light emitter 210 are focused the most. To implement such form, a hole 222 may be defined at a center of the light receiver 220 for the light emitter 210 to be disposed therein.

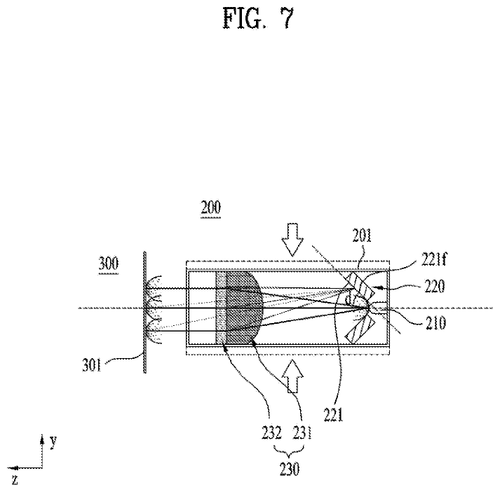

FIG. 7 shows an embodiment of the optical module 200 related to the present disclosure.

Because the optical module 200 is mounted on the pointing device 100, minimizing a size of the optical module 200 is directly related to minimizing a size and a weight of the pointing device 100.

As a method for minimizing the optical module 200, the light receiver 220 may be equipped with an inclined detector 221f That is, a light receiving surface 2211 of the detector 221f may be disposed by forming an inclination toward the optical axis by a specific angle d. Because the light receiving surface 2211 of the detector 221f is inclined, the detector 221f has a smaller width than the detector 221 (see FIG. 2) implemented in a first direction perpendicular to the optical axis. Because a width in the first direction of the casing 201 must be greater than a width in the first direction of the light receiver 220, the width in the first direction of the casing 201 may also become smaller as the width in the first direction of the light receiver 220 is minimized.

Furthermore, because the pointing device 100 is generally used at a certain angle with respect to the outside surface 301, the inclined detector 221f may tend to be more parallel to the outside surface 301 than the detector 221 (see FIG. 2), which is not inclined. Therefore, the detector 221f may perform accurate sensing for the same area.

When the light receiver 220 has a plurality of detectors 221 arranged along a perimeter of the light emitter 210, at least one detector 221 may be inclined. For example, when there are four detectors 221 respectively installed in portions above, below, left and right to the light emitter 210 as shown in FIG. 3, at least one detector 221 may be inclined. This is because even when only one detector 221 is inclined, a thickness of the optical module 200 may be minimized compared to a case in which all the four detectors are not inclined.

However, preferably, it is appropriate that all the arranged detectors 221 are configured to be inclined to minimize the overall thickness of the optical module 200 by respectively minimizing spaces of the arranged portions on the x-y plane.

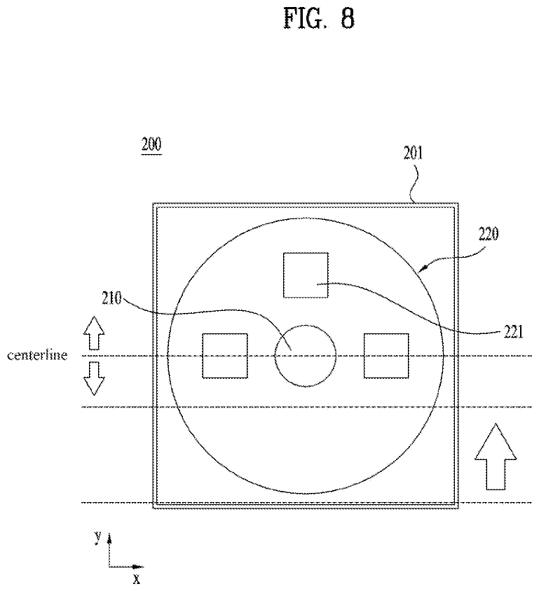

FIG. 8 shows another embodiment of the optical module 200 related to the present disclosure.

Unlike the previous embodiment, although algorithm for analyzing the movement of the pointing device 100 requires information of four points, statistically, an upward movement rarely occurs in the actual writing. In addition, a movement of the remaining detector may be estimated through information recognized by the three detectors 221, three detectors 221 may be implemented.

As an example, the detectors 221 may be respectively arranged at only three points of a total of four points, which are two points in the x-axis and two points in the y-axis of the light emitter 210. In this case, a thickness of the optical module 200 may be reduced in a direction in which the detector 221 is omitted.

Locations of the three detectors 221 are not limited. Each detector 221 may be disposed at any point of the light receiver 220. However, when dividing the light receiver 220 into regions of both sides based on a centerline passing through the light emitter 210 on the x-y plane, it is preferable in terms of the minimization of the optical module 200 that all the three detectors 221 are arranged in a region of one side.

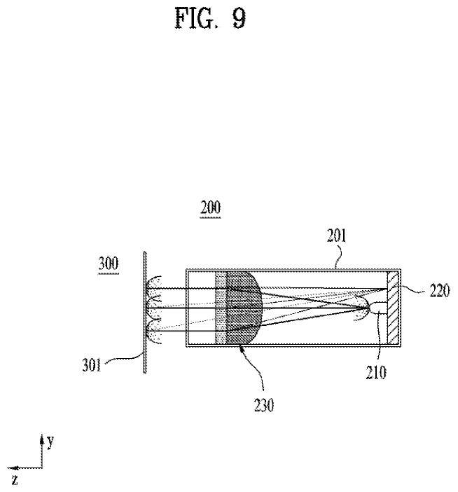

FIGS. 9 to 11 show some examples of the optical module 200 related to the present disclosure.

Regarding the locations of the detector 221 of the light receiver 220 and the light emitter 210, in the previous example, the detector 221 and the light emitter 210 are on the same line with respect to a z-axis direction. However, as in the following three embodiments, methods for differentiating the locations of the detector 221 and the light emitter 210 may be considered.

As an example, as shown in FIG. 9, the detector 221 may be located in rear of the light emitter 210 in the optical axis direction. In this case, the light receiver 220 equipped with the detector 221 does not need the hole 222 (see FIG. 6) for the light emitter 210 to be disposed therein, so that manufacturing cost and time may be reduced.

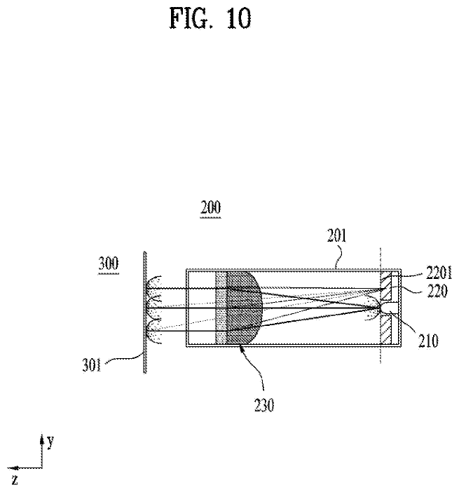

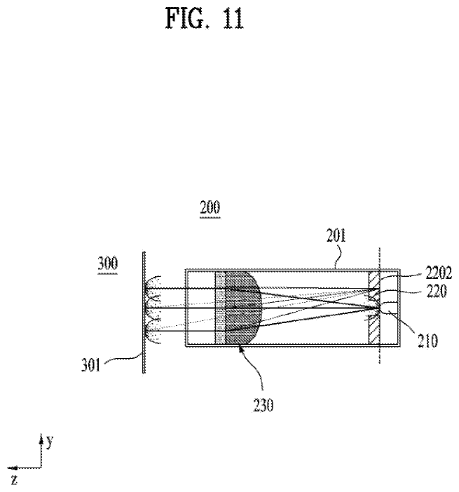

As another example, the detector 221 may be located on a front portion of the light emitter 210 in the optical axis direction as shown in FIGS. 10 and 11. FIG. 10 shows that a front end in the optical axis direction of the light emitter 210 and a front end 2201 in the optical axis direction of the detector 221 are on the same line. In addition, FIG. 11 shows that the front end in the optical axis direction of the light emitter 210 is on the same line as a rear end 2202 in the optical axis direction of the detector 221.

In the embodiment in FIG. 10 or FIG. 11, because the detector 221 is relatively located on the front side in the optical axis direction, there is an advantage that a reception sensitivity of the light reflected from the outside surface 301 outside the optical module 200 is higher than that in the other case.

It is obvious to a person skilled in the art that the present disclosure may be embodied in other specific forms without departing from the spirit and essential characteristics of the present disclosure.

The detailed description described above should not be construed as restrictive in all respects and should be considered as illustrative. The scope of the present disclosure should be determined by reasonable interpretation of the appended claims, and all changes within the scope of the present disclosure are included in the scope of the present disclosure.

### INDUSTRIAL AVAILABILITY

The above-described features of the present disclosure may be partially or entirely applied to the pointing device associated with the present disclosure.

What is claimed is:

1. A pointing device comprising:
an optical module for tracking a coordinate,
wherein the optical module includes:
a light emitter for irradiating light towards an outside surface;
a lens disposed between the light emitter and the outside surface to refract and diffract the light; and
a light receiver, wherein the light passed through the lens and then reflected from the outside surface reaches the light receiver,
wherein the light receiver includes a detector for sensing the reflected light,
wherein a light receiving surface of the detector is inclined at a specific angle with respect to an optical axis of the light emitter.

2. The pointing device of claim 1, wherein the optical module further includes a casing for mounting the light emitter, the lens, and the light receiver therein,
wherein a width of the casing with respect to a first direction perpendicular to the optical axis of the light emitter corresponds to a width occupied by the light receiver with respect to the first direction.

3. The pointing device of claim 1, wherein the lens includes:
a lens for performing the refraction of the light; and
a grating element for performing the diffraction of the light.

4. The pointing device of claim 1, wherein the lens includes a single lens for performing the refraction and the diffraction of the light.

5. The pointing device of claim 1, wherein the lens performs linear type diffraction and includes an aspherical lens.

6. The pointing device of claim 1, wherein the lens is a single grating element performing kinoform type diffraction.

7. A pointing device comprising:
an optical module for tracking a coordinate,
wherein the optical module includes:
a light emitter for irradiating light towards an outside surface;
a lens disposed between the light emitter and the outside surface to refract and diffract the light; and
a light receiver, wherein the light passed through the lens and then reflected from the outside surface reaches the light receiver,
wherein the light receiver has three detectors for sensing the light.

8. The pointing device of claim 7, wherein the three detectors are arranged biased on one side with respect to a centerline passing through the light emitter.

9. The pointing device of claim 8, wherein the three detectors are respectively disposed at three of four respective locations above, below, left and right to the light emitter.

10. A pointing device comprising:
an optical module for tracking a coordinate,
wherein the optical module includes:
a light emitter for irradiating light toward an outside surface and forming an optical path;
a lens disposed between the light emitter and the outside surface to refract and diffract the light; and
a light receiver, wherein the light passed through the lens and then reflected from the outside surface reaches the light receiver,
wherein the light receiver is located behind the light emitter in the optical path.

11. A pointing device comprising:
an optical module for tracking a coordinate,
wherein the optical module includes:
a light emitter for irradiating light toward an outside surface and forming an optical path;
a lens disposed between the light emitter and the outside surface to refract and diffract the light; and
a light receiver, wherein the light passed through the lens and then reflected from the outside surface reaches the light receiver,
wherein the light receiver is located in front of the light emitter in the optical path.
